(19) United States
(12) Patent Application Publication
(10) Pub. No.: US 2024/0402336 A1
(43) Pub. Date: Dec. 5, 2024

(54) METHOD FOR CHARACTERIZING AN OBJECT IN AN ENVIRONMENT OF A MOTOR VEHICLE

(71) Applicant: Continental Autonomous Mobility Germany GmbH, Ingolstadt (DE)

(72) Inventors: Wassim Suleiman, Kriftel (DE); Christopher Brown, Seligenstadt (DE); Abhishek Kekud, Frankfurt a. Main (DE)

(73) Assignee: Continental Autonomous Mobility Germany GmbH, Ingolstadt (DE)

(21) Appl. No.: 18/691,646

(22) PCT Filed: Aug. 22, 2022
(86) PCT No.: PCT/DE2022/200194

§ 371 Date: Mar. 13, 2024

(30) Foreign Application Priority Data
Sep. 13, 2021 (DE) 10 2021 210 082.1

(51) Int. Cl. G01S 15/931; G01B 17/02

(52) U.S. Cl. CPC G01S 15/931; G01B 17/02; G01S 2015/932

(57) ABSTRACT

A method for characterizing an object in the surroundings of a motor vehicle in which method the motor vehicle is moved relative to the object and ultrasonic signals are emitted with an ultrasonic sensor. Echoes of the ultrasonic signals reflected by the object are received, respective amplitudes of the received echoes are determined, and a classification of a height of the object is established based on the amplitudes.

### CROSS-REFERENCE TO RELATED APPLICATIONS

The present application is a National Stage Application under 35 U.S.C. § 371 of International Patent Application No. PCT/DE2022/200194 filed on Aug. 22, 2022, and claims priority from German Patent Application No. 10 2021 210 082.1 filed on Sep. 13, 2021, in the German Patent and Trademark Office, the disclosures of which are herein incorporated by reference in their entireties.

### TECHNICAL FIELD

The invention relates to a method for characterizing an object in the surroundings of a motor vehicle by means of an assistance system of the motor vehicle, in which method the motor vehicle is moved relative to the object and ultrasonic signals are emitted with an ultrasonic sensor of the assistance system. Echoes of the ultrasonic signals reflected by the object are received and respective amplitudes of the received echoes are determined by means of a control device, wherein a classification of a height of the object is established based on the amplitudes. The invention further relates to an assistance system having an ultrasonic sensor and having a control device which is designed to carry out such a method.

### BACKGROUND

Ultrasonic sensors usually comprise a transmitting device which emits ultrasonic signals which propagate in air at the speed of sound of approximately 340 meters per second. To this end, a membrane of the ultrasonic sensor is usually excited to mechanical vibrations with a corresponding transducer element. The ultrasonic signal is reflected as an echo by objects in the surroundings and detected by a receiver device of the ultrasonic sensor. The spacing or, in other words, the distance from the object can be determined on the basis of the transit time difference between the time of transmission and the time of reception, taking into account the speed of propagation of the ultrasonic signal. In this case, the amplitude of the reflected ultrasonic signal or of the echo can also be established.

Ultrasonic sensors for motor vehicles are usually deployed for capturing the environment in a range of up to approximately 7 meters. In particular, ultrasonic sensors are particularly important in the case of semi-automatic or automatic driving maneuvers, especially in connection with parking applications, for instance when measuring parking distances, searching for a parking space or during parking. The motor vehicle is usually moved relative to the objects, wherein a measurement cycle is carried out in each case at predetermined times during the movement. During each measurement cycle an ultrasonic signal is emitted with an ultrasonic sensor. Methods and corresponding assistance systems are already known from the prior art, which provide the driver with different information regarding the surroundings of the motor vehicle with the aid of ultrasonic sensors and support him during maneuvering of the motor vehicle and in particular when locating a parking space and when parking the motor vehicle in the parking space. For example, there exist assistance systems which are equipped with parking space locating and which indicate to the driver whether a parking space is available in the immediate surroundings of the motor vehicle or whether an available parking space is large enough in order to be able to park the motor vehicle therein. In order to reliably locate and dimension a parking space, such assistance systems require information regarding objects located in the surroundings of the motor vehicle, which objects can be formed, for example, by parked vehicles, curbs and walls.

In addition to the distance of the motor vehicle from an object, the height of the object is usually also important. The height is an important factor in order to be able to decide whether an object or obstacle can be driven over or not. In particular, when the motor vehicle is maneuvered at least semi-autonomously on the basis of the measurements of an ultrasonic sensor, it is desirable to determine the height of the captured object.

The height determination with one-dimensional (1D) ultrasonic sensors regularly used in the motor vehicle field, that is to say ultrasonic sensors for determining distances, is in principle really difficult due to physical limitations. The height of an object cannot be measured directly with the aid of such an ultrasonic sensor. In order to determine the height, a camera, for example, is therefore additionally used and the height is estimated based on a 2D image, or a method based on multiple sensors is used in order to estimate the height on the basis of triangulation. However, methods based on a camera or multiple sensors do not exploit the advantages of a 1D ultrasonic sensor in terms of cost and robustness.

A method and an assistance system of the type mentioned above are known, for example, from DE 10 2004 047 479 A1. In order to classify a height of an object when a motor vehicle drives past the object located to the side of the motor vehicle by means of an ultrasonic sensor of the motor vehicle, ultrasonic signals are emitted and the echoes of the ultrasonic signals reflected by the objects are received. The classification of the height of the object is determined based on an amplitude of a received echo.

There remains an opportunity to provide a method for characterizing an object in the surroundings of a motor vehicle as well as a corresponding assistance system which makes it possible to classify the height of the object in the most cost-effective and reliable manner possible.

### SUMMARY

In the case of a method for characterizing an object in the surroundings of a motor vehicle by means of an assistance system of the motor vehicle, the motor vehicle is moved relative to the object and ultrasonic signals are emitted with an ultrasonic sensor, in particular a 1D ultrasonic sensor, of the assistance system. Echoes of the ultrasonic signals reflected by the object are received, wherein, by means of a control device, respective amplitudes of the received echoes are determined, and wherein a classification of a height of the object is established based on the amplitudes.

A respective amplitude correction factor, which takes account of an azimuth angle of the object with respect to the ultrasonic sensor, is established for the received echoes, and the respective amplitudes are corrected based on the corresponding amplitude correction factor, wherein the classification of the height of the object is established on the basis of an established first change in amplitude by comparing a first corrected amplitude of a first echo with a second corrected amplitude of a second echo which was received after the first echo.

The disclosed method is initially based on the consideration that a cost-effective classification of the height of an object is made possible if recourse is had to a sensor of the motor vehicle, which is installed anyway, and that a particularly cost-effective and robust classification is further promoted by the fact that no computationally complex fusion which is prone to failure is carried out with sensor data of a further sensor or, more precisely of a further type of sensor, in particular a camera. Furthermore, the invention is based on the consideration that the radiation pattern of an ultrasonic sensor is, in principle, a function of the elevation angle and of the azimuth angle, that is to say that the power of an ultrasonic signal, which is emitted by an ultrasonic sensor to an object in the capturing range, depends on the elevation angle and on the azimuth angle of the object with respect to the ultrasonic sensor. In the case of an object which is located at a height, that is to say in particular has a height, which is less than the installation height of the ultrasonic sensor in the motor vehicle, the elevation angle and, thus, the power, or in other words the amplitude, of the reflected ultrasonic signal change, accordingly, as a function of the distance between the motor vehicle or the ultrasonic sensor and the object, in particular below a certain distance between the object and motor vehicle, more precisely the ultrasonic sensor. In particular, this fact can be utilized in order to establish the classification of the height of an object.

Therefore, the disclosed method provides that the classification of the height of the object based on the sensor data of an ultrasonic sensor moving relative to the object, in particular of a 1D ultrasonic sensor, is established, wherein a respective amplitude correction factor, which takes account of an azimuth angle of the object with respect to the ultrasonic sensor, is determined for the received echoes, and the respective amplitudes are corrected based on the corresponding amplitude correction factor, and wherein the classification of the height of the object is established on the basis of an established first change in amplitude by comparing a first corrected amplitude of a first echo with a second corrected amplitude of a second echo which was received after the first echo.

The advantage of the configuration described herein is that a method is thereby provided, by which a cost-effective and reliable classification of the height of the object is made possible including, in particular, if the azimuth angle of the object changes relative to the ultrasonic sensor during the movement of the motor vehicle.

The objects to be characterized can be objects which extend from the ground, for example a road surface or other terrain, and extend substantially orthogonally to the ground. However, they can also be objects which do not extend from the ground such as, for example, a crossbar of a fence, or which do not extend orthogonally to the ground such as, for example, a ramp.

The ultrasonic sensor, in particular a 1D ultrasonic sensor, can be arranged, for example, in or behind a bumper of the motor vehicle. Alternatively, the ultrasonic sensor, in particular a 1D ultrasonic sensor, can be arranged in or behind a body component, for example a door of the motor vehicle.

Only a single ultrasonic sensor, in particular a 1D ultrasonic sensor, can be used. Alternatively, multiple ultrasonic sensors, in particular multiple 1D ultrasonic sensors, can however also be used.

In particular, the two classes “high” and “low” are used as the classification of the height of the object. The object is classified as “high” if the object is located at least at the installation height of the ultrasonic sensor, that is to say if the object in particular has a height which corresponds at least to the installation height of the ultrasonic sensor. The object is classified as “low” when the object is located below the installation height of the ultrasonic sensor, that is to say when the object in particular has a height which is less than the installation height of the ultrasonic sensor.

The azimuth angle indicates a position of the object with respect to the ultrasonic sensor in a horizontal direction. An influence in a change in the position of the object with respect to the ultrasonic sensor in a horizontal direction is compensated for by the correction of the amplitudes of the received echoes with a respective amplitude correction factor.

An amplitude is corrected in particular by a scaling of the value of the amplitude based on the corresponding amplitude correction factor, preferably by a multiplication or a division of the value of the amplitude with the corresponding amplitude correction factor, wherein the result of the multiplication or division constitutes the corrected amplitude.

In an advantageous embodiment, the amplitude correction factor is dependent on a horizontal radiation pattern of the ultrasonic sensor. That is to say that the amplitude correction factor of a received echo is established based on the azimuth angle of the object with respect to the ultrasonic sensor and the horizontal radiation pattern of the ultrasonic sensor. The radiation pattern reproduces the power of the ultrasonic signal which is emitted by the ultrasonic sensor, as a function of the azimuth angle. That is to say that the radiation pattern defines a determined power value of the ultrasonic signal for each azimuth angle. On the basis of the radiation pattern for the present azimuth angle, the power value of the corresponding ultrasonic signal which is assigned to this azimuth angle is advantageously read out, which power value is then directly used as the amplitude correction factor or in order to establish the amplitude correction factor of the received echo.

In a further advantageous embodiment, the azimuth angle is determined by trilateration on the basis of echoes which were received in time before the first echo and the second echo, and/or based on signals of an environment sensor of the motor vehicle, which differs from the ultrasonic sensor. The environment sensor can be configured as a radar sensor, a lidar sensor and/or a camera.

In a further advantageous embodiment, the first echo and the second echo are successive echoes over time, in particular echoes which immediately succeed one another in time.

In a further advantageous embodiment, the object is located in the immediate vicinity of the motor vehicle, preferably at a distance of up to two meters from the ultrasonic sensor of the motor vehicle, wherein when the motor vehicle approaches the object, the object is classified as low if a decrease in amplitude over the course of time is established as the first change in amplitude, and wherein the object is classified as high if an increase in amplitude over the course of time is established as the first change in amplitude. The classification as low is in particular established for an object which is located below the installation height of the ultrasonic sensor, that is to say which in particular has a height which is less than the installation height of the ultrasonic sensor. Such an object is, for example, a curb. The classification as high is in particular established for an object which is located at least at the installation height of the ultrasonic sensor, that is to say which in particular has a height which corresponds at least to the installation height of the ultrasonic sensor. Such an object is, for example, a wall, a fence or a vehicle.

This is based on the fact that in the case of an object which is located at least at the installation height of the ultrasonic sensor, the elevation angle does not change while the motor vehicle or the ultrasonic sensor is moving towards the object. Consequently, the power, or in other words the corrected amplitude, of the reflected ultrasonic signal or echo merely depends on the distance between the object and the ultrasonic sensor. The corrected amplitude of the reflected ultrasonic signal is greater when the motor vehicle, more precisely the ultrasonic sensor, approaches such an object, that is to say when the distance between the object and the ultrasonic sensor becomes smaller. By contrast, in the case of an object which is located below the installation height of the ultrasonic sensor, the elevation angle changes below a determined distance between the object and the ultrasonic sensor and continues to decrease while the motor vehicle or the ultrasonic sensor is moving towards the object. The corrected amplitude of the reflected ultrasonic signal becomes smaller when the motor vehicle or the ultrasonic sensor approaches such an object. It is true that the corrected amplitude itself becomes greater, the smaller the distance between the object and the ultrasonic sensor becomes. However, by way of contrast, the dominant factor here is that the elevation angle becomes smaller as the distance decreases, as a result of which the corrected amplitude of the reflected ultrasonic signal accordingly decreases overall.

In a further advantageous embodiment, the classification of the height of the object is established on the basis of a comparison of the first change in amplitude with a second change in amplitude, wherein the second change in amplitude is established by comparing a third corrected amplitude of a third echo which was received after the second echo, with the second corrected amplitude of the second echo or with a fourth corrected amplitude of a fourth echo which was received after the second echo and before the third echo. That is to say that, in this case, two changes in amplitude are compared with one another, as a result of which the robustness of the classification of the height of the object is further promoted.

In a further advantageous embodiment, when the motor vehicle approaches the object, the object is classified as low if an increase in amplitude over the course of time is established as the first change in amplitude and a decrease in amplitude over the course of time is established as the second change in amplitude.

This is based on the fact that in the case of an object such as, for example, a curb which is located below the installation height of the ultrasonic sensor, that is to say which in particular has a height which is less than the installation height of the ultrasonic sensor, when said object is in particular not yet located in the immediate vicinity of the motor vehicle, preferably at a distance of greater than two meters from the ultrasonic sensor of the motor vehicle, the elevation angle is at least approximately 90°. Accordingly, the power, or in other words the corrected amplitude, of the reflected ultrasonic signal is substantially merely dependent on the distance between the object and the ultrasonic sensor. The corrected amplitude of the reflected ultrasonic signal or echo is initially greater when the motor vehicle or the ultrasonic sensor approaches such an object, that is to say when the distance between the object and the ultrasonic sensor becomes smaller. That is to say that the first change in amplitude results in an increase in amplitude over the course of time here. When the motor vehicle or the ultrasonic sensor continues to approach said object and the object is then in particular located in the immediate vicinity of the motor vehicle, preferably at a distance of less than two meters from the ultrasonic sensor of the motor vehicle, the elevation angle changes as said motor vehicle or ultrasonic sensor continues to approach said object, wherein said elevation angle becomes less than 90° and gradually decreases further as said motor vehicle or ultrasonic sensor continues to approach said object or the distance is further reduced. This leads to the corrected amplitude of the reflected ultrasonic signal also gradually decreasing as said motor vehicle or ultrasonic sensor continues to approach said object. It is true that the corrected amplitude itself becomes greater, the smaller the distance between the object and the ultrasonic sensor becomes. However, by way of contrast, the dominant factor here is that the elevation angle becomes smaller as the distance decreases, as a result of which the corrected amplitude of the reflected ultrasonic signal accordingly decreases overall. That is to say that the second change in amplitude results in a decrease in amplitude over the course of time here. That is to say that when, based on the comparison of the first change in amplitude with the second change in amplitude, an increase in amplitude over the course of time has been established as the first change in amplitude and a decrease in amplitude over the course of time has been established as the second change in amplitude, the object is classified as low.

In a further advantageous embodiment, the object is located in the immediate vicinity of the motor vehicle, preferably at a distance of up to two meters from the ultrasonic sensor of the motor vehicle, wherein when the motor vehicle approaches the object, the object is classified as low if a decrease in amplitude over the course of time is established in each case as the first change in amplitude and as the second change in amplitude, and if the second change in amplitude is additionally greater than the first change in amplitude. That is to say that a measure of the decrease in amplitude is taken into account here.

This is based on the fact that in the case of an object such as, for example, a curb which is located below the installation height of the ultrasonic sensor, that is to say which in particular has a height which is less than the installation height of the ultrasonic sensor, when said object is located in the immediate vicinity of the motor vehicle, preferably at a distance of less than two meters from the ultrasonic sensor of the motor vehicle, the elevation angle gradually decreases, while the motor vehicle or the ultrasonic sensor continues to move toward the object. This leads to the corrected amplitude of the reflected ultrasonic signal or echo also gradually decreasing as said motor vehicle or ultrasonic sensor approaches said object. It is true that the corrected amplitude itself becomes greater, the smaller the distance between the object and the ultrasonic sensor becomes. However, by way of contrast, the dominant factor here is that the elevation angle becomes smaller as the distance decreases, as a result of which the corrected amplitude of the reflected ultrasonic signal accordingly decreases overall. That is to say that the second change in amplitude results in a decrease in amplitude over the course of time, which is greater than the decrease in amplitude of the first change in amplitude, as a result of which the object is classified as low.

In a further advantageous embodiment, the object is located in the immediate vicinity of the motor vehicle, preferably at a distance of up to two meters from the ultrasonic sensor of the motor vehicle, wherein when the motor vehicle approaches the object, the object is classified as high if an increase in amplitude over the course of time is established in each case as the first change in amplitude and as the second change in amplitude, and if the second change in amplitude is additionally greater than the first change in amplitude. That is to say that a measure of the increase in amplitude is taken into account here.

This is based on the fact that in the case of an object such as, for example a wall, a fence or a vehicle which is located at least at the installation height of the ultrasonic sensor, that is to say which in particular has a height which corresponds at least to the installation height of the ultrasonic sensor, even if this object is located in the vicinity of the motor vehicle, preferably at a distance of less than two meters from the ultrasonic sensor of the motor vehicle, the elevation angle does not change while the motor vehicle or the ultrasonic sensor is moving towards the object. Consequently, the power, more precisely the corrected amplitude, of the reflected ultrasonic signal merely depends on the distance between the object and the ultrasonic sensor. The corrected amplitude of the reflected ultrasonic signal or echo becomes greater when the motor vehicle or the ultrasonic sensor approaches such an object, that is to say when the distance between the object and the ultrasonic sensor becomes smaller. That is to say that the second change in amplitude results in an increase in amplitude over the course of time here, which is greater than the increase in amplitude of the first change in amplitude, as a result of which the object is classified as high.

In a further advantageous embodiment, the comparison of the changes in amplitude is based on a difference and/or a ratio of the changes in amplitude.

In a further advantageous embodiment, the comparison of the corrected amplitudes is based on a difference and/or a ratio of the corrected amplitudes.

In a further advantageous embodiment, the classification of the height of the object is established when the first change in amplitude, according to amount, additionally lies above a predefined threshold. In this way, the reliability of the establishment of the classification of the height of the object is further increased. In one embodiment, in which the second change in amplitude is additionally or alternatively taken into account, the classification of the height of the object is preferably established if, additionally or alternatively, the second change in amplitude, according to amount, lies above a predefined threshold.

In a further advantageous embodiment, the threshold is predetermined as a function of a current speed of the motor vehicle and/or a temperature in the surroundings of the motor vehicle and/or an air humidity in the surroundings of the motor vehicle and/or an installation height of the ultrasonic sensor on the motor vehicle. Since the temperature in the surroundings of the motor vehicle has noticeable effects on the airborne sound insulation, the temperature can be captured with the aid of a corresponding sensor and the threshold can be adjusted thereto. The same applies to the air humidity. This leads to an even more reliable classification of the height of the object.

In a further advantageous embodiment, the method is applied during an assisted and/or semi-automatic and/or automatic parking method.

The present invention furthermore comprises an assistance system having an ultrasonic sensor and having a control device. The control device is designed for carrying out the method according to the invention.

The advantages and preferred embodiments described for the method according to the invention also apply correspondingly to the assistance system according to the invention.

### BRIEF DESCRIPTION OF THE DRAWINGS

Exemplary embodiments are explained in greater detail below on the basis of a drawing, wherein:

FIG. 1 shows a radiation diagram which depicts a radiation pattern of an ultrasonic sensor as a function of the azimuth angle,

FIG. 2 shows a radiation diagram which depicts a radiation pattern of an ultrasonic sensor as a function of the elevation angle,

FIG. 3 shows a diagram which depicts the elevation angle as a function of the distance of the ultrasonic sensor according to FIG. 2 from an object, and

FIG. 4 shows a flowchart of a method for characterizing an object in the surroundings of a motor vehicle.

### DETAILED DESCRIPTION

Corresponding parts are constantly provided with the same reference numerals in all figures.

A radiation diagram is shown in FIG. 1, which depicts a radiation pattern 1 of an ultrasonic sensor as a function of the azimuth angle. From this it can be seen that the radiation pattern 1 of the ultrasonic sensor is a function of the azimuth angle, that is to say that the power of an ultrasonic signal which is emitted by an ultrasonic sensor to an object in the capturing range and, consequently, the power, or in other words the amplitude, of the ultrasonic signal reflected by the object or echo also depends on the azimuth angle.

When the object is located, for example, at an azimuth angle of 30° with respect to the ultrasonic sensor, then the power, or in other words the amplitude, of the ultrasonic signal reflected by the object or echo is greater than when the object is located at an azimuth angle of 60° with respect to the ultrasonic sensor.

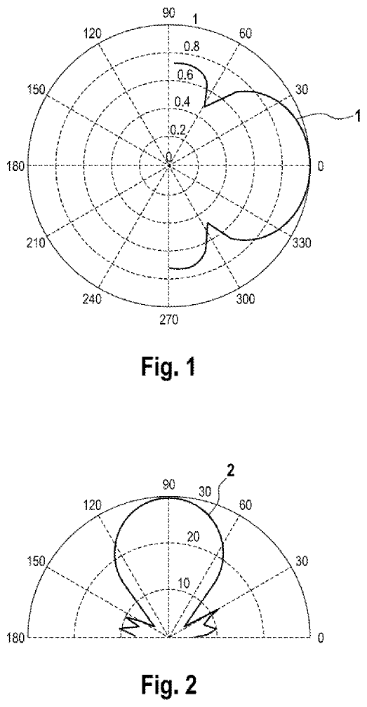

A radiation diagram is shown in FIG. 2, which depicts a radiation pattern 2 of an ultrasonic sensor as a function of the elevation angle. It is obvious therefrom that the radiation pattern 2 of the ultrasonic sensor is a function of the elevation angle, that is to say that the power of an ultrasonic signal, which is emitted by an ultrasonic sensor to an object in the capturing range, depends on the elevation angle.

When an object is located at an elevation angle of 90°, i.e., at least at an installation height of the ultrasonic sensor in a motor vehicle, then the elevation angle does not change when the motor vehicle, more precisely the ultrasonic sensor, approaches the object. The power, or in other words the amplitude, of the reflected ultrasonic signal or echo only depends on the distance between the ultrasonic sensor and the object. The amplitude of the reflected ultrasonic signal therefore becomes gradually greater when the motor vehicle or the ultrasonic sensor approaches a high object.

Accordingly, in the case of an object which has a height which is less than the installation height of the ultrasonic sensor in the motor vehicle, the elevation angle and, thus, the power or amplitude of the reflected ultrasonic signal change as a function of the distance between the motor vehicle or ultrasonic sensor and the object. When the motor vehicle or ultrasonic sensor approaches the object, the elevation angle does of course become gradually smaller until it reaches approximately 0° as soon as the ultrasonic sensor is located directly on the object.

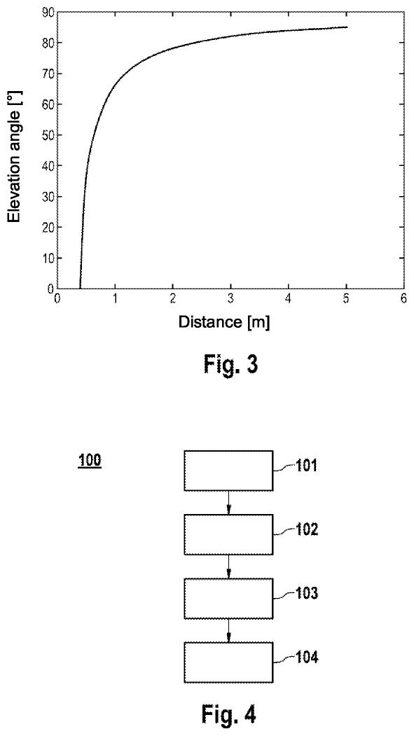

FIG. 3 shows a diagram which depicts the elevation angle as a function of the distance of the ultrasonic sensor according to FIG. 2 from an object. The object has a height which is 40 cm lower than the installation height of the ultrasonic sensor in the motor vehicle. The object is configured as a curb here.

It is obvious from the diagram that when the object is not yet located in the immediate vicinity of the motor vehicle, in particular at a distance of greater than two meters from the ultrasonic sensor of the motor vehicle, the elevation angle is approximately 90°. Accordingly, in this range, the power, or more precisely the amplitude, of the reflected ultrasonic signal substantially merely depends on the distance between the object and the ultrasonic sensor. The amplitude of the reflected ultrasonic signal becomes greater when the motor vehicle or the ultrasonic sensor approaches such an object, that is to say when the distance between the object and the ultrasonic sensor becomes smaller.

When the motor vehicle or the ultrasonic sensor continues to approach the object and the object is then located in the immediate vicinity of the motor vehicle, in particular at a distance of less than two meters from the ultrasonic sensor of the motor vehicle, the elevation angle gradually reduces noticeably as said motor vehicle or ultrasonic sensor continues to approach said object. This leads to the amplitude of the reflected ultrasonic signal also gradually decreasing as said motor vehicle or ultrasonic sensor continues to approach said object. It is true that the amplitude itself becomes greater, the smaller the distance between the object and the ultrasonic sensor becomes. However, by way of contrast, the dominant factor here is that the elevation angle becomes smaller as the distance decreases, as a result of which the amplitude of the reflected ultrasonic signal accordingly decreases overall.

The fundamental precondition of the relationship described regarding FIGS. 2 and 3 is that during the movement of the motor vehicle, the azimuth angle of the object does not change with respect to the ultrasonic sensor. Since, in practice, the situation frequently occurs that during the movement of the motor vehicle, the azimuth angle of the object changes with respect to the ultrasonic sensor, this change is taken into account according to the invention during the characterization of the object by the establishment and use of an amplitude correction factor which takes into account the azimuth angle of the object with respect to the ultrasonic sensor. In this way, the relationship described regarding FIGS. 2 and 3 can be utilized in order to establish the classification of the height of an object, including in the event of a change in the azimuth angle of the object with respect to the ultrasonic sensor during the movement of the motor vehicle.

FIG. 4 shows a flowchart of a method 100 for characterizing an object in the surroundings of a motor vehicle. The motor vehicle comprises an assistance system with a control device and a 1D ultrasonic sensor which is arranged on a front bumper of the motor vehicle, and which has a radiation pattern according to FIGS. 1 and 2. The front of the motor vehicle continues to approach the object from a distance of approximately 2.5 meters and the ultrasonic sensor continuously emits ultrasonic signals. The object is a curb which has a height which is approximately 40 cm lower than the installation height of the ultrasonic sensor in the motor vehicle.

In a step 101, a first echo is received and a first amplitude of the first echo is determined. In addition, a current azimuth angle of the object is determined with respect to the ultrasonic sensor by trilateration on the basis of echoes which were received in time before the first echo, and an amplitude correction factor for the first echo is established based on the azimuth angle determined in the present case and the horizontal radiation pattern 1 of the ultrasonic sensor according to FIG. 1. To this end, the power value of the ultrasonic signal assigned to this azimuth angle is read out on the basis of the radiation pattern 1 for the azimuth angle determined in the present case, which power value is then used in order to establish the amplitude correction factor. Subsequently, the first amplitude is corrected by a scaling of the value of the first amplitude based on the amplitude correction factor, in particular by a multiplication or a division of the value of the first amplitude with the amplitude correction factor, wherein the result of the scaling, in particular of the multiplication or division, constitutes the corrected first amplitude.

In a subsequent step 102, a second echo which follows the first echo in time is received and a second amplitude of the second echo is determined. In addition, a current azimuth angle of the object is determined with respect to the ultrasonic sensor by trilateration on the basis of echoes which were received in time before the second echo, and an amplitude correction factor for the second echo is established based on the azimuth angle determined in the present case and the horizontal radiation pattern 1 of the ultrasonic sensor according to FIG. 1. To this end, the power value of the ultrasonic signal assigned to this azimuth angle is read out on the basis of the radiation pattern 1 for the azimuth angle determined in the present case, which power value is then used in order to establish the amplitude correction factor. Subsequently, the second amplitude is corrected by a scaling of the value of the second amplitude based on the amplitude correction factor, in particular by a multiplication or a division of the value of the second amplitude with the amplitude correction factor, wherein the result of the scaling, in particular of the multiplication or division, constitutes the corrected second amplitude.

In a step 103, a first change in amplitude is established on the basis of a comparison of the first corrected amplitude with the second corrected amplitude. In the present case, an increase in amplitude is established. Since the object was not yet in the immediate vicinity of the motor vehicle at the time of the measurement, that is to say was still at a distance of greater than two meters from the ultrasonic sensor of the motor vehicle, the elevation angle is approximately 90°. Accordingly, here, the corrected amplitude of the reflected ultrasonic signal substantially merely depends on the distance between the object and the ultrasonic sensor. That is to say that the corrected amplitude of the reflected ultrasonic signal becomes greater when the motor vehicle or the ultrasonic sensor approaches such an object, that is to say when the distance between the object and the ultrasonic sensor becomes smaller. Here, the first change in amplitude results in an increase in amplitude over the course of time.

Since the object was not yet in the immediate vicinity of the motor vehicle at the time of the measurement, no final classification of the height of the object takes place yet based on the established change in amplitude and the method 100 goes back to step 102. Consequently, a further third echo which follows the second echo in time is received and a third corrected amplitude of the third echo is determined.

Subsequently, a second change in amplitude is established on the basis of a comparison of the second corrected amplitude with the third corrected amplitude in step 103. Since the motor vehicle has meanwhile continued moving in the direction of the object and, at the time of the further measurement, the object is now located in the immediate vicinity of the motor vehicle and, here, specifically at a distance of 0.5 meters from the motor vehicle or ultrasonic sensor, a decrease in amplitude is established as the second change in amplitude. This is based on the fact that the elevation angle in this area is now significantly smaller than 90°, which leads to the corrected amplitude of the reflected ultrasonic signal decreasing overall, as a result of which the third corrected amplitude of the third echo is smaller than the second corrected amplitude of the second echo. That is to say that the second change in amplitude results in a decrease in amplitude over the course of time here.

In a step 104, a classification of the height of the object is established. To this end, a comparison of the first change in amplitude with the second change in amplitude takes place. Since, in the present case, an increase in amplitude over the course of time is established as the first change in amplitude and a decrease in amplitude over the course of time is established as the second change in amplitude, the object is classified as low.

Based on this method 100, the height of the object, in the present case of the curb, can be classified in a cost-effective and reliable manner, including in particular if the azimuth angle of the object changes relative to the ultrasonic sensor during the movement of the motor vehicle.

1-15. (canceled)

16. A method for characterizing an object in the surroundings of a motor vehicle utilizing an assistance system of the motor vehicle, in which the motor vehicle is moved relative to the object, said method comprising:
emitting ultrasonic signals with an ultrasonic sensor of the assistance system;
receiving echoes of the ultrasonic signals reflected off the object;
determining respective amplitudes of the received echoes with a control device;
establishing a classification of a height of the object is based on the amplitudes with the control device;
establishing a respective amplitude correction factor, which takes account of an azimuth angle of the object with respect to the ultrasonic sensor, for the received echoes;
correcting the respective amplitudes based on the corresponding amplitude correction factor;
establishing the classification of the height of the object based on an established first change in amplitude by comparing a first corrected amplitude of a first echo with a second corrected amplitude of a second echo which was received after the first echo.

17. The method according to claim 16, wherein the amplitude correction factor is dependent on a horizontal radiation pattern of the ultrasonic sensor.

18. The method according to claim 16, wherein the azimuth angle is determined by trilateration on the basis of echoes which were received in time before the first echo and the second echo, and/or based on signals of an environment sensor of the motor vehicle which differs from the ultrasonic sensor.

19. The method according to claim 16, wherein the first echo and the second echo are successive echoes over time.

20. The method according to claim 16, wherein the object is located at a distance of up to two meters from the ultrasonic sensor of the motor vehicle, in that when the motor vehicle approaches the object, the object is classified as low if a decrease in amplitude over time is established as the first change in amplitude, and in that the object is classified as high if an increase in amplitude over the course of time is established as the first change in amplitude.

21. The method according to claim 16, wherein the classification of the height of the object is established based on a comparison of the first change in amplitude with a second change in amplitude, and in that the second change in amplitude is established by comparing a third corrected amplitude of a third echo which was received after the second echo with the second corrected amplitude of the second echo or with a fourth corrected amplitude of a fourth echo which was received after the second echo and before the third echo.

22. The method according to claim 21, wherein when the motor vehicle approaches the object, the object is classified as low if an increase in amplitude over the course of time is established as the first change in amplitude and a decrease in amplitude over the course of time is established as the second change in amplitude.

23. The method according to claim 21, wherein the object is located at a distance of up to two meters from the ultrasonic sensor of the motor vehicle, in that when the motor vehicle approaches the object, the object is classified as low if a decrease in amplitude over the course of time is established in each case as the first change in amplitude and as the second change in amplitude, and if the second change in amplitude is additionally greater than the first change in amplitude.

24. The method according to claim 21, wherein the object is located at a distance of up to two meters from the ultrasonic sensor of the motor vehicle, that when the motor vehicle approaches the object, the object is classified as high if an increase in amplitude over the course of time is established in each case as the first change in amplitude and as the second change in amplitude, and if the second change in amplitude is additionally greater than the first change in amplitude.

25. The method according to claim 21, wherein the comparison of the changes in amplitude is based on a difference and/or a ratio of the changes in amplitude.

26. The method according to claim 16, wherein the comparison of the corrected amplitudes is based on a difference and/or a ratio of the corrected amplitudes.

27. The method according to claim 16, wherein the classification of the height of the object is established if the first change in amplitude, according to amount, additionally lies above a predefined threshold.

28. The method according to claim 27, wherein the threshold is predetermined as a function of a current speed of the motor vehicle and/or a temperature in the surroundings of the motor vehicle and/or an air humidity in the surroundings of the motor vehicle and/or an installation height of the ultrasonic sensor on the motor vehicle.
